(19) United States
(12) Patent Application Publication
(10) Pub. No.: US 2003/0213744 A1
(43) Pub. Date: Nov. 20, 2003

(54) High-throughput asymmetric membrane

(76) Inventors: Willem Kools, Winchester, MA (US); Claire Goulding, Groton, MA (US); Daniel Calnan, Lynn, MA (US); Timothy Dolan, Groton, MA (US)

Correspondence Address: MILLIPORE CORPORATION, 290 CONCORD ROAD, BILLERICA, MA, 01821, US

(21) Appl. No.: 10/439,057

(22) Filed: May 15, 2003

Related U.S. Application Data
(60) Provisional application No. 60/381,468, filed on May 17, 2002.

(51) Int. Cl. B01D 69/00

(52) U.S. Cl. 210/500.21; 210/500.1

(57) ABSTRACT

A microporous asymmetrical membrane formed of one or more layers wherein the “tight” side of the membrane has an “opened” face or otherwise highly-porous reticulated surface is described. The microporous asymmetrical membrane has high throughput and high flux, even when used for filtering viscous materials, such as serum or plasma. The membrane's surface can be formed by ablation or solvation, or in a two or more layered structure, through an appropriate selection of casting dopes.

The present invention claims the benefit of U.S. Provisional Pat. App. Ser. No. 60/381,468, filed May 17, 2002.

### FIELD

In general, the present invention relates to asymmetric membranes and, more particularly, to an asymmetric membrane having a substantially reticulated surface microstructure.

### BACKGROUND

Asymmetric membranes—in use for many years—are characterized by having the pore size of the membrane vary as a function of location within the thickness of the membrane. The most common asymmetric membrane has a gradient structure, in which pore size gradually and continually increases from one surface (often referred to as the “tight” side) to the other (often referred to as the “open” side). These membranes are valued as they have a higher flux than comparable symmetric membranes. When used in the configuration with their larger pore side upstream, these membranes have greater throughput in many cases as compared to the comparable symmetric membranes. See, U.S. Pat. No. 4,261,834, issued to D. M. de Winter on Apr. 14, 1981. The asymmetrical membranes are used in a variety of applications such as food and beverage filtration, pharmaceutical and biopharmaceutical manufacture, laboratory filtration, water filtration and the like.

Asymmetrical membranes based on aromatic sulphones such as polyethersulphones are preferred as they are capable of use at elevated temperatures and highly acidic and basic conditions.

Asymmetric membranes all have a thick, dense surface region or in many cases a skin formed on the surface and extending somewhat into its depth. See, U.S. Pat. No. 4,629,563. issued to W. Wrasidlo on Dec. 16, 1986. The dense surface and/or skin can be seen through the use of photomicrographs. The dense surface is shown as a continuous dense film surface punctuated by a myriad of pores. The skin can be seen in cross-sectional photomicrographs as a dense layer extending into the thickness of the membrane. See, U.S. Pat. No. 4,629,563.

More recently, a multiple layered asymmetric membrane has been produced. See PCT International Publication No. WO 01/89673. This membrane is formed of two or more layers that are co-cast simultaneously from two or more different solutions of membrane precursor material. Unique asymmetrical structures can formed with the membranes of this invention.

While most asymmetric membranes work satisfactorily on water or aqueous based solutions, they tend to prematurely clog and have poor throughput with viscous or heavily loaded streams, even when used in the preferred open side upstream configuration. Such streams are relatively common and can include various food streams such as syrups and sugary products, serum streams as used in the biopharmaceutical or laboratory settings or blood, plasma and other blood products.

In light of the above, there is a need for a membrane having high throughput and flux, suitable for filtering high volumes of fluid, and for filtering quickly a given volume of liquid.

### SUMMARY

The present invention is directed to a microporous asymmetrical membrane formed of one or more layers, wherein the “tight” side of the membrane has an “opened” or otherwise highly porous reticulated surface, said surface being configured to promote high throughput. The microporous asymmetrical membrane has high throughput and high flux, even when used for viscous fluids such as serum or plasma.

While the present invention is not intended to be limited to any theory used in explanation thereof, it is believed that the highly porous reticulated surface provides comparatively more openings for flow, and provides greater interconnectivity among different pores in the structure, hence reducing the propensity of the pores to plug completely.

The membrane surface can be formed by ablation or salvation, or in a two or more layered structure, through a so-called “co-cast” methodology involving an appropriate selection of casting dopes.

### BRIEF DESCRIPTION OF THE DRAWINGS

FIG. 1A shows a photomicrograph of a “skinless” asymmetrical membrane in cross-section.

FIG. 1B shows the tight surface of the membrane of FIG. 1A.

FIG. 2A shows photomicrograph of a cross-section of a two-layered asymmetrical membrane according to the present invention.

FIG. 2B shows the tight surface of the membrane of FIG. 2A.

FIG. 3 is a graph of the flow times of the membranes in Example 1.

FIG. 4 is a graph of the flux of the membranes in Example 1.

FIG. 5 is a graph of the flow times of the membranes in Example 2.

FIG. 6 is a graph of the flux of the membranes in Example 2.

FIG. 7 shows a photomicrograph of the tight surface of a low porosity surfaced membrane according to the prior art.

FIG. 8 shows a photomicrograph of the tight surface of a low porosity surfaced membrane according to the prior art after being surface modified by the techniques of the present invention.

FIG. 9 is a graph of the nearest neighbor pore data.

FIG. 10 shows a photomicrograph of the tight surface of a membrane according to the prior art.

FIG. 11 shows a photomicrograph of the tight surface of a membrane according to the present invention.

FIG. 12 is a graph plotting data described in Example 7.

### DETAILED DESCRIPTION

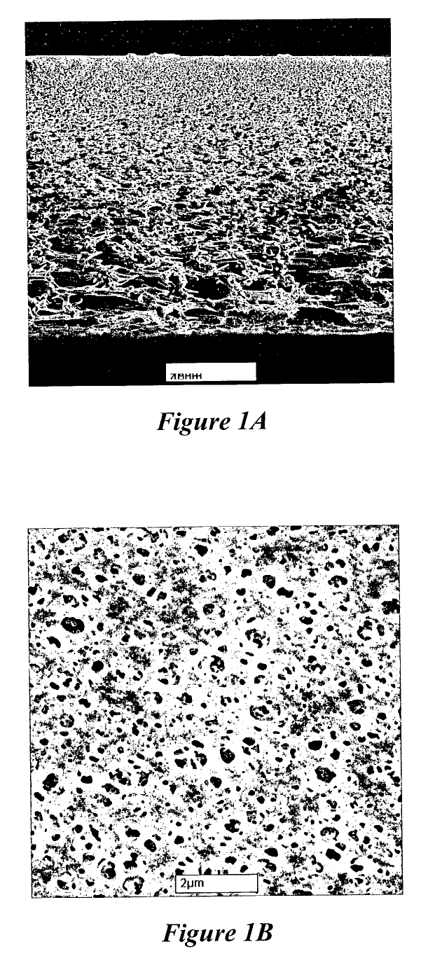

Certain microporous asymmetrical membranes have a “skin” formed in their tight side. See e.g. U.S. Pat. No. 4,629,563. Those that don't have the “skin” often have a “skin surface” or otherwise reduced porosity tight surface. FIGS. 1A and 1B—illustrative of such prior art—show a cross section and a tight surface photomicrograph, respectively, of a skin-surfaced asymmetrical membrane. In FIG. 1B, the tight surface of the membrane has a relatively low percentage of porosity.

The present invention, in contrast, provides an asymmetrical microporous membrane well-suited for high throughput filtration, the membrane being distinguished by its reticulated porous surface, formed or otherwise provided on the membrane rather than or instead of a skin or skin-type surface. In combination with its other structural features, the reticulated porous surface is configured for, and hence affords, a bubble point normalized serum flow time of less than about 2.

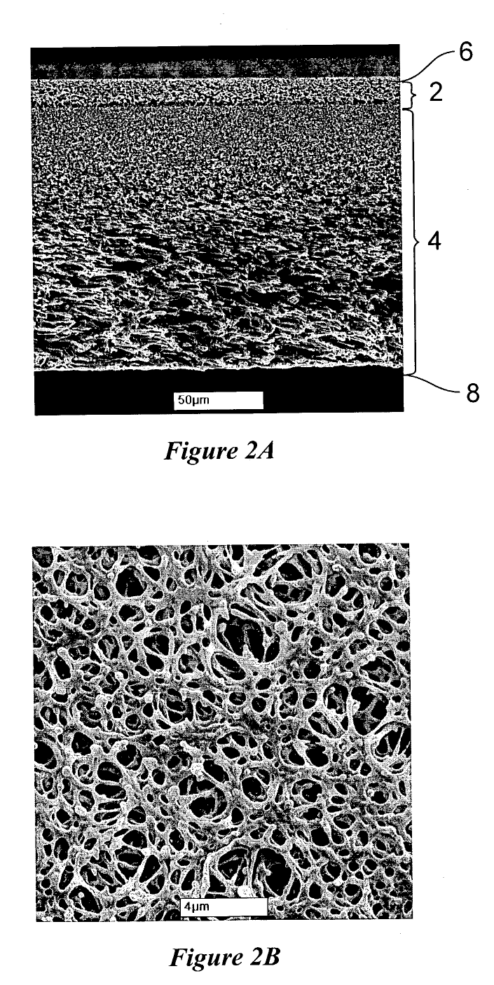

One embodiment of the present invention is shown in FIGS. 2A and 2B. In this embodiment, the structure is formed of two layers, each cast from a different solution of membrane precursor, according a base methodology that is otherwise disclosed in PCT International Publication No. WO 01/89673. As seen in FIG. 2A, the structure shows the two layers 2 and 4 with asymmetric porosity throughout the structure from one side 6 to the other 8. The top layer 2 is relatively thinner than the bottom layer. As shown in FIG. 2B, the surface of the tight side of the membrane has an open, highly reticulated porous surface.

A second embodiment of the present invention is made from a preformed single- or multiple-layered asymmetrical membrane in which the porosity of the tight side is too low for acceptable throughput or flux for its predetermined intended use. In accord with the invention, the tight surface of the membrane is modified to create a surface with higher porosity (i.e., the surface is “opened”), yielding an open, reticulated surface.

Post-formation modification is applicable to both single-layered asymmetric membranes and two-layered membranes made as per WO 01/89673 (i.e., in which the porosity of the tight side is still too low for acceptable throughput or flux).

Post-formation surface modification can be accomplished in a variety of ways: e.g., mechanically, chemically, or by exposure to irradiation.

Mechanically, certain membrane surfaces can be abraded with fine sandpaper or emery material (600 grit+); or sandblasted with sand, silica, ground corn husk, or nut shells under conditions sufficient to yield an open, reticulated surface.

Chemically, certain membrane surfaces can be exposed to a solvent to partially remove surface polymer material. Chemical modification has several advantages, among which is that the depth to which the solvent influences removal can be controlled. For example, the pores of the membrane can be filled with a non-solvent immiscible with the surface-modifying solvent, thus limiting interaction of the solvent to exposed non-solvent or other diluent will affect the concentration, and hence, reactivity of the solvent. Desirable methods will employ combination of both filling the pores with non-miscible non-solvent and controlling solvent concentration.

Certain membrane surfaces can also be exposed to electromagnetic radiation of an intensity, a wavelength, and for a duration sufficient and/or appropriate to remove, or render removable, exposed portions of the surface polymer material. Methods of irradiation include, but are not limited to, corona discharge, plasma ablation, and laser ablation. Details of such methods are available in the patent and technical literature.

When forming a multi-layered structure, a preferred method follows closely the regimen prescribed in PCT International Publication No. WO 01/89673. In particular, two different membrane precursor solutions are simultaneously cast onto a support to form thereon the two or more layers. The solution coated support is then processed in a coagulation bath. Optionally, the solvent or solvents are extracted. The support, if temporary, is then removed. The resultant two layer membrane is then dried, rendering it essentially ready for use.

One can form the different solutions for the different layers by varying the concentration of polymer, solvent or non-solvent, as well as the viscosity, additives or treatments of the solutions or combinations of any of these to create the desired multi-layered structure. Other methods, including sequential casting, air casting, melt casting, and other phase inversion type methods, are well known and can be used to make the multi-layered structures.

A single-layered structure can be made according to any of U.S. Pat. Nos. 4,629,563, 5,444,097, 5,869,174, and 5,886,059. In these processes, one forms a solution, either stable or metastable, and then casts the solution onto a support, optionally exposes the material to the atmosphere for a set period of time, then places the membrane into a coagulation bath. Optionally, one removes the solvent and the support, if temporary, and then dries the resultant membrane.

Preferred polymers for either embodiment include but are not limited to PVDF, nylons such as Nylon 66, polyamides, polyimides, polyethersulphones, polysulphones, polyarylsulphones, PVC, PET, polycarbonates, cellulose, regenerated cellulose, cellulose esters such as cellulose acetate or cellulose nitrate, polystyrenes, polyetherimides, acrylic polymers, methacrylic polymers, copolymers of acrylic or methacrylic polymers, or blends of any of the above and the like.

The polymer solutions of the present invention typically comprise at least one polymer and at least one solvent for the polymer or polymers. The solution may contain one or more components that are poor solvents or non-solvents for the polymer or polymers. Such components are sometimes called “porogens” in the art. The solutions are preferably homogeneous. They can optionally contain one or more components, which are non-solvents for the polymer. The polymer solution can be either stable in time (good solvent quality) or meta-stable in time. The solution also can potentially have a lower critical solution temperature or an upper critical solution temperature. Example components of such solutions are well known in the art. Useful solvents include dimethyl formamide, N,N-dimethylacetamide, N-methyl pyrrolidone, tetramethylurea, acetone, dimethylsulfoxide. Useful porogens include formamide, various alcohols and polyhydric compounds, water, various polyethylene glycols, and various salts, such as calcium chloride and lithium chloride.

One can form the layers of a multi-layered structure from the same polymer and solvent, varying the concentration of components, viscosity, additives and treatment (before, during or after formation) or one can use different polymers for the different layers. When using different polymers one must select polymers that are compatible. Additionally, the solvents and phase separation materials should be the same if possible or at least compatible so that they do not adversely affect the other layer(s).

The microporous structures of the present invention may have an average pore size of from about 0.01 microns to about 10 microns, preferably from about 0.01 to about 2 microns.

Asymmetrical membranes may have a pore size gradient of from about 2:1 to about 1000:1, preferably from about 2:1 to about 100:1. This asymmetry is measured by comparing the average pore size on one major surface of the layer with the average pore size of the other major surface of that layer. In accord with the invention, one can create two or more asymmetrical layers, each having a different or similar asymmetry.

Additionally, one can vary the thickness of the membrane and, if two or more layers are used, the thickness of each layer within a wide range and still obtain a self-supporting, integral multi-layered structure. Typically, it is desirable for the thickness of the membrane structure to be between 50 and 200 microns as this provides good filtration characteristics and self support. With the present invention one can still achieve the same overall thickness but can control the relative thickness of one layer to the other to create unique and desirable membrane structures. Typically, one can make one layer as thin as 10 microns and it will result in an integral multilayered structure so long as the remaining structure is a suitable thickness. Thus, for example, in a 150 micron thick membrane, one can have a first layer that is from about 10 to about 140 microns thick while the other is correspondingly from about 140 microns to about 10 microns in thickness.

### EXAMPLES

### Example 1

A test solution comprising 1 liter of Fetal Bovine Serum (FBS) (available from JRH Bioscience, Inc. of Lenexa, Kans.), 1 bottle of Dubelco Modified Eagle medium (133.7 g) (available from Invitrogen/Gibco of Carlsbad, Calif.), 37 grams of sodium bicarbonate, 100 ml Hepes buffer solution (available Sigma-Aldrich US of St-Louis. Mo.), and 10 liters deionized water was prepared. The solution was stirred before use.

A 47 mm disk was placed in a vacuum filter holder. The flow time in seconds was measured for 500 ml of water and for various volumes of the solution using 16 inches Hg on three different asymmetrical membranes: i.e., an asymmetrical polysulfone membrane from US Filter Corporation (now Pall Corporation of East Hills, N.Y.); a 0.2 micron Express membrane available from Millipore Corporation of Bedford, Mass.; and 4 membranes of the present invention (Samples 1A-D).

The water flow rates were as follows:

| | | Water Flow Rate | |
|---|---|---|---|
| Membrane | Bubble Point (psi) | (500 ml)(sec) | Porosity (%) |
| US Filter | 60 | 75 | 81 |
| Millipore Express | 67 | 99 | 78 |
| Sample 1A | 63.6 | 68 | 79 |
| Sample 1B | 76.6 | 72 | 79 |
| Sample 1C | 63.1 | 64 | 79 |
| Sample 1D | 67.7 | 61 | 79 |

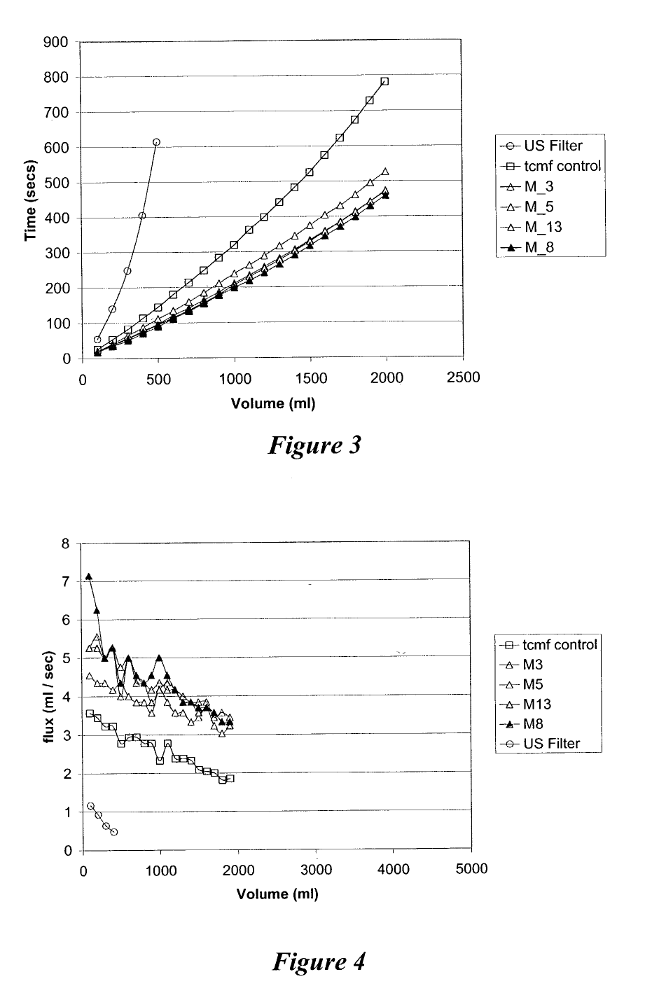

Plotting the flow times needed to filter certain amounts of the solution, the graph shown in FIG. 3 was generated. It can be seen therein that the membranes of the present invention has a clear advantage, a shorter flow time, over the membranes of the prior art. Good results are obtained in respect of the total volume that can be filtered by such membranes, as well as the speed at which such membranes filter a standard amount of solution (500 ml).

Surprisingly, the flux of the Sample membranes is higher, and remains higher, than the prior art membranes. (See FIG. 4).

Based upon this data, one can extrapolate and estimate the total amount of fluid that can be filtered by these filters with sufficiently high flux:

| | Total Volume | Initial Flux | |
|---|---|---|---|
| | Filtered Estimated | (at 100 ml | Flux at 500 ml |
| Membrane | (Liters) | filtered) | Filtered (ml/sec) |
| US Filter | 0.6 | 1.2 | 0.4 |
| Millipore Express | 3.7 | 3.6 | 2.7 |
| Sample 1A | 5.7 | 5.0 | 4.0 |
| Sample 1B | 5.2 | 4.3 | 4.3 |
| Sample 1C | 5.7 | 5.0 | 4.3 |
| Sample 1D | 5.7 | 5.0 | 4.7 |

### Example 2

A test solution comprising of 250 ml New Born Calf Serum (Gibco BRL), 1 bottle of Dubelco Modified Eagle medium (133.7 g.), 37 grams of sodium bicarbonate, 100 ml Hepes buffer solution, and 10 liters deionized water was prepared. The solution was stirred before use.

A 47 mm disk was placed in a vacuum filter holder Using a vacuum of 16 inches Hg, the flow time in seconds was measured for various volumes of the solution on a 0.2 micron Express membrane available from Millipore Corporation of Bedford, Mass., and 4 sample membranes of the present invention (Samples 2A-D).

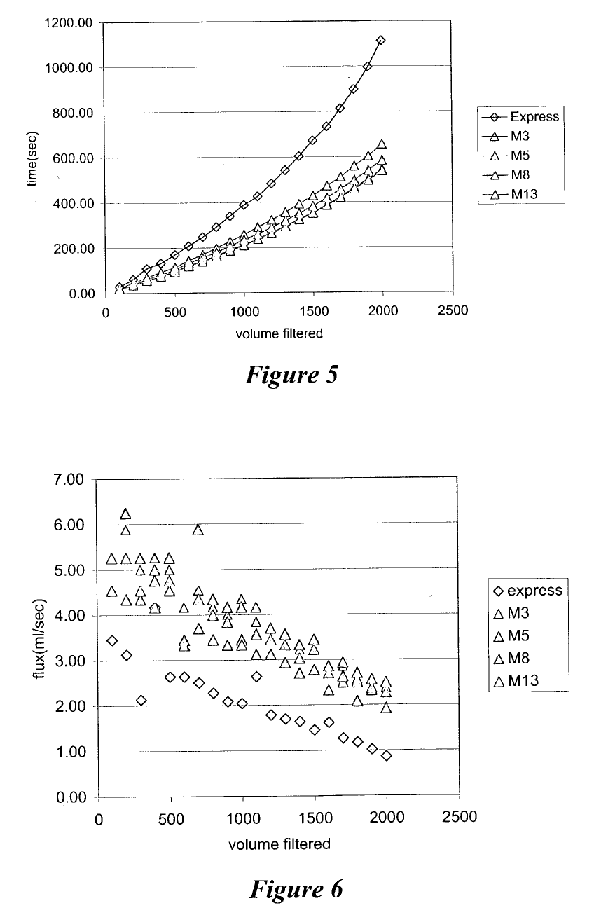

FIGS. 5 and 6—prepared from data from this Example—shows that the sample membranes of the present invention outperformed the prior art membrane.

Plotting the flow times to filter certain volumes of the solution indicates that the sample membranes have an advantage over existing membranes in both flow and the total volume that can be filtered. Estimations on the volume that can be filtered through a 47 mm diameter disk based on the data of this experiment are given below:

| | | Initial Flux | |
|---|---|---|---|
| | Total Volume Filtered | (at 100 ml | Flux at 500 ml |
| Membrane | Estimated (Liters) | filtered) | (ml/sec) |
| Millipore Express | 2.7 | 3.5 | 2.6 |
| Sample 2A | 3.6 | 5.2 | 5.0 |
| Sample 2B | 3.5 | 4.6 | 4.6 |
| Sample 2C | 3.7 | 5.3 | 5.2 |
| Sample 2D | 3.5 | 5.3 | 4.8 |

### Example 3

A co-cast membrane was made in accordance with the methodology described in PCT International Publication No. WO 01/89673 (18%+12% PES-NMP-TEG). The total thickness of the resultant membrane was about 140 micron, with the upper layer within the membrane measuring about 10 microns in thickness. This membrane had a similar bubble point as a 0.45 rated Supor membrane (Pall-Gelman). Flow was tested on both water and fetal bovine serum. The following table shows the decreased time for this membrane to filter 500 ml of serum through a 47 mm disk. For reference, an 0.2 rated Express(TM) membrane was used.

| | | BP | Flow time | |
|---|---|---|---|---|
| time | | IPA | water | Flow time |
| FBS (sec) | Orientation | (psi) | (sec) | FBS (sec) |
| Express | Shiny Side Downstream | 22 | 100 | 162 |
| Example 3 | Shiny Side Upstream | 11.5 | 32 | 95 |
| Example 3 | Shiny Side Downstream | 11.5 | 32 | 58 |
| 0.45 Supor | Shiny Side Downstream | 12 | 68 | 138 |
| 0.45 Supor | Shiny Side Upstream | 12 | 68 | Unable to |
| | | | | filter 500 ml |

### Example 4

A fetal bovine serum test was performed on 4 different types of membranes: a single layer asymmetric membrane of the prior art (Express™ membrane), a PES co-cast membrane, a Sartopore 2 asymmetrical membrane (both layers in orientation of the cartridge from which they were removed), and the 0.2 rated membrane layer of the Sartopore 2 product (available from Sartorius AG of Goettingen, Germany).

This resulted in the following times (in seconds) to filter 500 ml of FBS:

| Membrane | Flow Time FBS (sec) |
|---|---|
| Express TM | 159 |
| Express TM | 169 |
| Example 4 | 113 |
| Sartopore 2 (0.45 + 0.2) | 500 |
| Sartopore 2 (0.2 layer) | >900 for 450 ml |

### Example 5

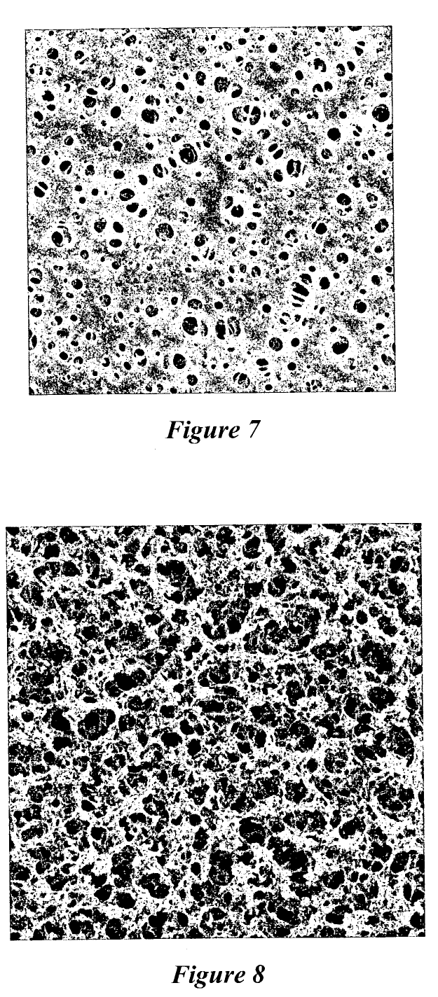

Two pieces of single layer microporous asymmetric membrane with different bubble points (Millipore Express 0.2 micron membrane available from Millipore Corporation of Bedford, Mass.) were obtained. The low porosity surface on the tight side of each membrane was ablated in a plasma chamber using oxygen. FIG. 7 shows the tight surface of one of the membranes before plasma ablation. FIG. 8 shows the tight surface of that membrane after plasma ablation.

The ablated membranes were tested for flow and throughput.

As observed, the removal of the low porosity layer by plasma ablation resulted in an increased performance over non-treated samples. In particular, there was an approximately 25% decrease in water flow time as compared to non-treated membranes. For fetal bovine serum (FBS) flow time decreased by about 17%.

The data suggests that the improved performance is not simply a function of the change in bubble point. In this regard, one can assume that a linear relationship exists between water bubble point and water flow time and FBS flow time. The relationship, determined from empirical data, was 4.8 sec/psi for water flow time and 2.8 sec/psi FBS. With this relationship, the performance improvement cannot be attributable to the bubble point change alone. A change in only the bubble point would create an expected performance increase of only about 10% for water flow time and 4% for FBS. Increased surface porosity has a measurable positive impact on the membrane performance.

### Example 6

To quantify the differences between a typical tight-sided asymmetric membrane of the prior art and a highly reticulated structure of the present invention, the pore distributions on the tight of side of a prior art membrane (Millipore Express 0.2 membrane) and a membrane of the present invention (a two layered structure having a pore size rating of 0.2 micron) was analyzed. Using photomicrographs of the respective tight surfaces, two measurements were made: “fractionated area percent”, which is a measure of the surface porosity; and “nearest neighbor distance”, which is a measure of the average distance between pores. Based upon these measurements, the following data was gathered.

| | Fractionated Area Percent | | Nearest Neighbor | |
|---|---|---|---|---|
| | Prior Art | Invention | Prior Art | Invention |
| Mean | 6.778 | 16.010 | 0.571 | 0.398 |
| Standard Deviation | 0.755 | 0.978 | 0.186 | 0.099 |

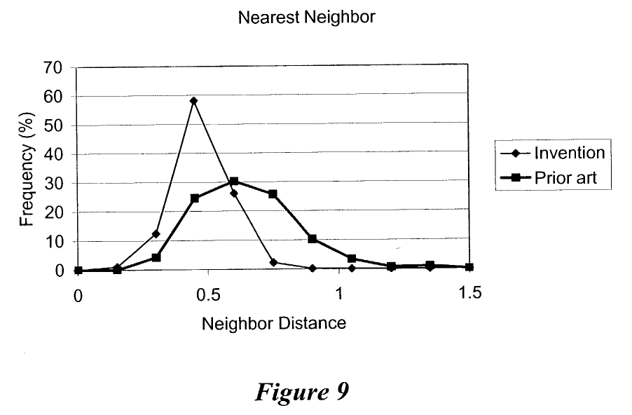

FIG. 9 shows a graphical representation of the Nearest Neighbor data for the two membranes.

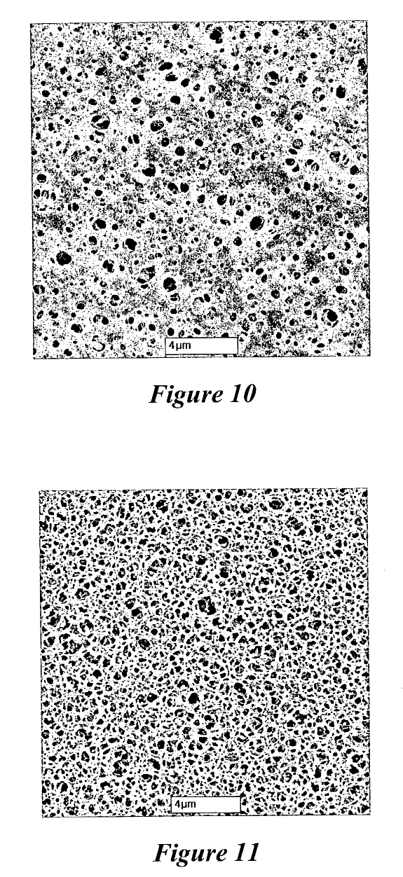

FIG. 10 shows a photomicrograph of the tight surface of the present invention used in this example.

FIG. 11 shows a photomicrograph of the tight surface of the prior art membrane used in the example.

The fractionated Area Percent for the membrane of the present invention is more than 2 times that of the prior art membrane. Likewise, the spacing between adjacent pores on the tight surface of the membrane of the present invention is nearly half that of the prior art membrane.

### Example 7

A co-cast membrane was made in accordance with methodology described in PCT International Publication No. WO 01/89673. A fetal bovine serum (FBS) test and water flow time test were performed on the resultant “low bubble point” surface-modified co-cast membrane. A flow time (500 ml of FBS) of 41 seconds and a water visual bubble of 21.5 psi were observed, yielding a ratio (i.e., FBS flow time divided by water flow time) of 1.9.

The FBS flow time test was conducted as described in Example 1. In particular, test solution was made of 1 liter of Fetal Bovine Serum, 1 bottle of Dubelco Modified Eagle medium, 37 grams of sodium bicarbonate, 100 ml Hepes solution and 10 liters deionized water. The solution was stirred before use. A 47 mm disk was placed in a vacuum filter holder and sealed with a vacuum holder funnel. Using a vacuum of 16 inches Hg, the flow time in seconds is measured for filtering 500 ml of serum solution and was 41 seconds. The water bubble point measured on the disk was 21.5 psi.

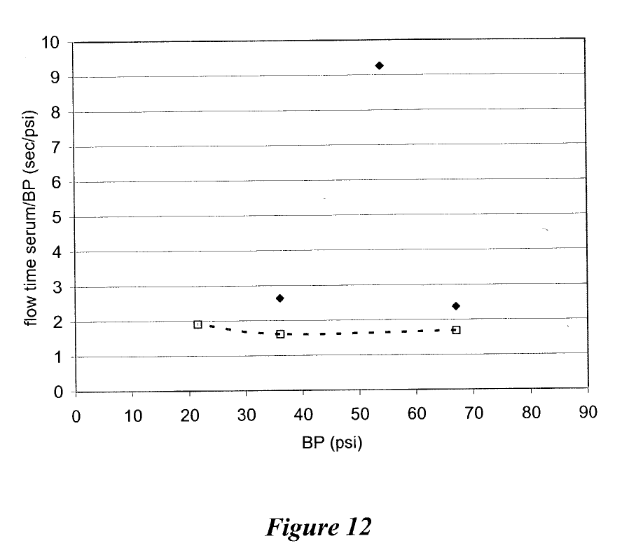

Using the above data, FBS flow time (sec) is then divided by the water bubble point (psi). This ratio is captured in FIG. 12 and the following table:

| | | | ratio FBS FT/BP |
|---|---|---|---|
| | water BP (psi) | FBS flow time (sec) | (sec/psi) |
| Supor | 36 | 95 | 2.6 |
| TCMF | 67 | 159 | 2.4 |
| Sartopore | 54 | 900 | 16.7 |
| Sartopore 2 | 54 | 500 | 9.3 |
| Example 4 | 67 | 113 | 1.7 |
| Example 3 | 36 | 58 | 1.6 |
| Example 7 | 21.5 | 41 | 1.9 |

The inventive membranes (Examples 3, 4, and 7) each have a BP corrected FBS flow time smaller than 2. The values for the other commercial membranes are significantly higher.

1. An asymmetrical microporous membrane suitable for high throughput applications, comprising polymeric material, having a reticulated porous surface, and having a bubble point normalized serum flow time of less than about 2.

2. The asymmetrical microporous membrane of claim 1, wherein said membrane comprises a single porous layer, said layer having a tight side and an open side, said reticulated porous surface being located on said tight side.

3. The asymmetrical microporous membrane of claim 1, wherein said membrane comprises more than one porous layer, said membrane having a tight side and an open side, said reticulated porous surface being located on said tight side.

4. The asymmetrical microporous membrane of claim 1, wherein said reticulated porous surface is formed by partial removal of said polymeric material by mechanical means.

5. The asymmetrical microporous membrane of claim 1, wherein said reticulated porous surface is formed by partial removal of said polymeric material by chemical agents.

6. The asymmetrical microporous membrane of claim 1, wherein said reticulated porous surface is formed by partial removal of said polymeric material by exposure to electromagnetic radiation.
